(19) United States
(12) Patent Application Publication
(10) Pub. No.: US 2019/0355001 A1
(43) Pub. Date: Nov. 21, 2019

(54) METHOD AND SYSTEM FOR INTEGRATING A FEEDBACK GATHERING SYSTEM OVER EXISTING WIFI NETWORK ACCESS

(71) Applicants: VIVEK KUMAR, murrysville, PA (US); DEEPENDRA TEWARI, GHAZIABAD (IN); ASHIMA SOOD, LUDHIANA (IN)

(72) Inventors: VIVEK KUMAR, murrysville, PA (US); DEEPENDRA TEWARI, GHAZIABAD (IN); ASHIMA SOOD, LUDHIANA (IN)

(21) Appl. No.: 16/197,376

(22) Filed: Nov. 21, 2018

Related U.S. Application Data
(60) Provisional application No. 62/596,963, filed on Dec. 11, 2017.

(51) Int. Cl. G06Q 30/02; H04W 60/00; G06Q 30/00; G06Q 50/12

(52) U.S. Cl. CPC G06Q 30/0203; G06Q 50/12; G06Q 30/016; H04W 60/00

(57) ABSTRACT

In one aspect, a computerized process useful for integrating a feedback gathering mechanism into a captive-portal system provided over a radio wireless local area network, includes the step of detecting a user's computing device is connected to the captive-portal system of the radio wireless local area network. The process includes the step of providing a feedback form as an over a captive portal to the user's computing device. The feedback form comprises a set of multiple-choice questions answerable by a user. The process includes the step of linking the multiple-choice questions in a way such that the choice of answer for a question at any stage decides a subsequent question. The process includes the step of implicitly tying the multiple-choice questions to a specified set of categories.

### CLAIM OF PRIORITY AND INCORPORATION BY REFERENCE

This application claims priority from U.S. Provisional Application No. 62/596,963, title METHOD AND SYSTEM FOR INTEGRATING A FEEDBACK GATHERING SYSTEM OVER EXISTING WIFI NETWORK ACCESS and filed 11 Dec. 2017. This application is hereby incorporated by reference in its entirety for all purposes.

### FIELD OF THE INVENTION

The invention is in the field of computer networking and more specifically to a method, system and apparatus of integrating a feedback gathering system over existing WIFI network access.

### DESCRIPTION OF THE RELATED ART

Hotels (and/or other venues) can provide Internet access to clients. Additionally, the hotel may wish to implement a method to analyze and/or manage guest feedback. Current forms of guest feedback involve paper forms that may not be analyzed for weeks or months by a non-local corporate office. Accordingly, current methods of dealing with potential causes of a guest's negative experience may not be made known to the venue in a timely enough manner to prevent the guest from publishing complaints in online forums. At the same time, guests often use the venue's local Wi-Fi Hotspot. Accordingly, improvements to gather feedback of the client's experience at the hotel so far over the captive portal page at the first time they try to login over the Wi-Fi network to gain internet access are desired.

### SUMMARY

In one aspect, a computerized process useful for integrating a feedback gathering mechanism into a captive-portal system provided over a radio wireless local area network, includes the step of detecting a user's computing device is connected to the captive-portal system of the radio wireless local area network. The process includes the step of providing a feedback form-over a captive portal to the user's computing device. The feedback form comprises a set of multiple-choice questions answerable by a user. The process includes the step of linking the multiple-choice questions in a way such that the choice of answer for a question at any stage decides a subsequent question. The process includes the step of implicitly tying the multiple-choice questions to a specified set of categories.

### BRIEF DESCRIPTION OF THE DRAWINGS

FIG. 1 illustrates an example process for integrating a feedback gathering system over existing WIFI network access, according to some embodiments.

FIG. 2 illustrates an example process for feedback form a captive portal in such a manner that the end user will not see them as a typical login form/captive portal, according to some embodiments.

FIG. 3 is a block diagram illustrating selected elements of a physical routing device, according to some embodiments.

FIG. 4 depicts an architecture block diagram of an example captive-portal system, according to some embodiments.

FIG. 5 depicts an exemplary computing system that can be configured to perform any one of the processes provided herein.

FIG. 6 is a block diagram of a sample computing environment that can be utilized to implement various embodiments.

FIG. 7 illustrates an example process useful for integrating a feedback gathering mechanism into a captive-portal system provided over a radio wireless local area network, according to some embodiments.

The Figures described above are a representative set and are not an exhaustive with respect to embodying the invention.

### DESCRIPTION

Disclosed are a system, method, and article of manufacture of integrating a feedback gathering system over existing WIFI network access. the following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Captive portal can be a special web page that is shown before using the Internet normally. The portal is often used to present a login page. This can be done by intercepting data packets, regardless of address or port, until the user opens a browser and tries to access the web.

Controller can be a routing device that can manage and direct the flow of traffic between the WLAN connected hosts and the Internet via the WAN port and provide services such as Authentication, Authorization, Auditing, Advertising, Analytics etc. Such services maybe locally hosted within the same memory space or hosted outside the routing device and referred to via the LAN or WAN ports.

Hotspot (WIFI) can be a WIFI network access point or area. In one example, a hotspot can be a site that offers Internet access over a wireless local area network (WLAN) through the use of a router connected to a link to an Internet service provider.

Local area network (LAN) can be a computer network that interconnects computers within a limited area such as a home, school, computer laboratory, or office building, using network media.

Port can be an application-specific or process-specific software construct serving as a communications endpoint in a computer's host operating system router. As used herein, a port can be a physical port or a virtual port.

Virtual LAN can be as group of devices on one or more LANs that are configured to communicate as if they were attached to the same wire, when in fact they are located on a number of different LAN segments.

Virtual port can be an internet protocol (IP) alias bound to a physical port. For example, it can share all of the network settings (except the IP address) with an associated physical port.

Wide area network (WAN) is a telecommunications network or computer network that extends over a large geographical distance.

WIFI can be a local area wireless technology that allows an electronic device to exchange data or connect to the Internet (e.g. using 2.4 GHz UHF and 5 GHz SHF radio waves).

Wireless local area network (WLAN) can be a wireless computer network that links two or more devices using a wireless distribution method within a limited area such as a home, school, airport terminal, office building, etc.

Example Methods and Processes

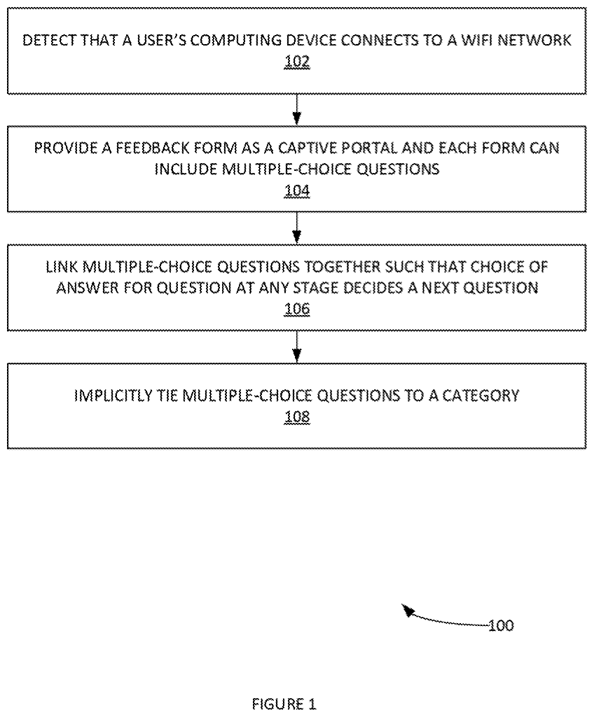

FIG. 1 illustrates an example process 100 for integrating a feedback gathering system over existing WIFI network access, according to some embodiments. In step 102, it can be detected that a user's computing device (e.g. a smart phone, a tablet computer, a laptop computer, etc.) can be connected to a local WIFI network. In step 104, a feedback form(s) can be provided as a captive portal. For example, a set of forms can be provided via/as a captive portal. Each form can include multiple-choice questions. In step 106, the multiple-choice questions can be linked together in a way such that the choice of answer for the question at any stage decides the next question.

In step 108, the multiple-choice questions can also be implicitly tied to categories to which they belong. Example categories include, inter alia: cleanliness, noise etc. A customer can answer and/other otherwise assign a value to a multiple-choice question. The answers to the multiple-choice question can be grouped into a severity range. In one example, the severity range can be grouped into good, neutral or bad categories. However, it is noted that each of these severity categories can be customizable and include keywords/tags. The keywords/tags can enable search and/or various grouping operations. Process 100 can be implemented using any existing network of Access Points airing WIFI signals along with their associated set of switches, routers and controllers.

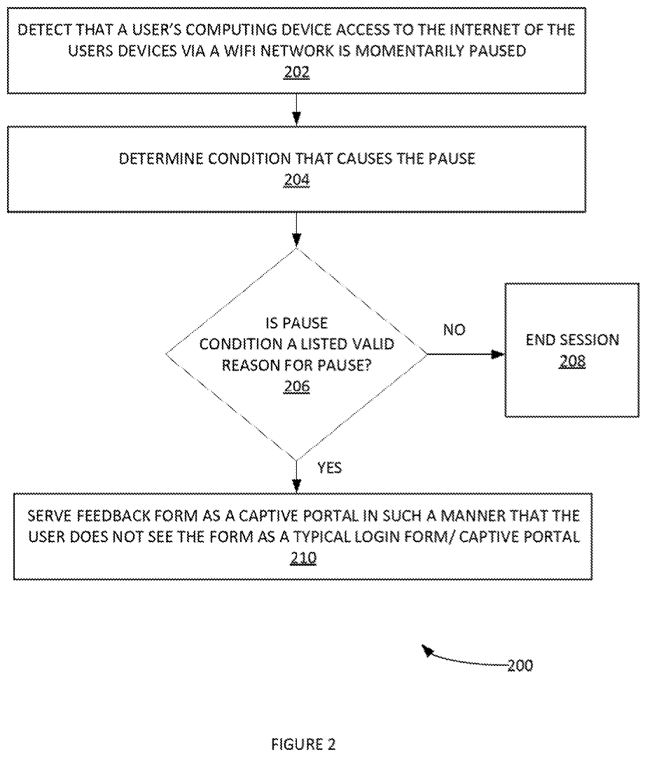

FIG. 2 illustrates an example process 200 for feedback form a captive portal in such a manner that the end user will not see them as a typical login form/captive portal, according to some embodiments. The user may not see the form right away when the user (it is noted that ‘user’ can include the user's computing device) connect to a WIFI network. As such the feedback form itself is an independent mechanism that is served and displayed on the user's computing device when the Internet access (via the WIFI network) of the user's computing device is momentarily paused.

Accordingly, in step 202, process 200 can detect that a user's computing device access to the Internet of the user's computing device(s) via a WIFI network is momentarily paused.

In step 204, process 200 can determine a reason for the cause of the pause. The conditions that can trigger such a pause can be any one or a combination of the following (among others). In one case, the user may have been given Internet access for a specified number of hours (e.g. at various events or a concerts). In one case, the user may have completed a specified number of disconnects or connects (e.g. in an office environments). In one case, the pause may occur at a specified hour of a specified day(s) (e.g. in an office environment or event). In one case, the first connect of a specified date of month (e.g. in an office environment) may be detected. In one case, a first connect of a specified day of week (useful in office environments) may be detected. In one case, a user may visit a particular domain after connecting the first time (e.g. in retail space). In one case, the user may wish/indicate a desire to provide proactively feedback by visiting a particular domain such as help.me or hear.me (e.g. in retail environments and healthcare). It is noted that such domains can only be visible locally on the controller's LAN side.

Exemplary Computer Architecture and Systems

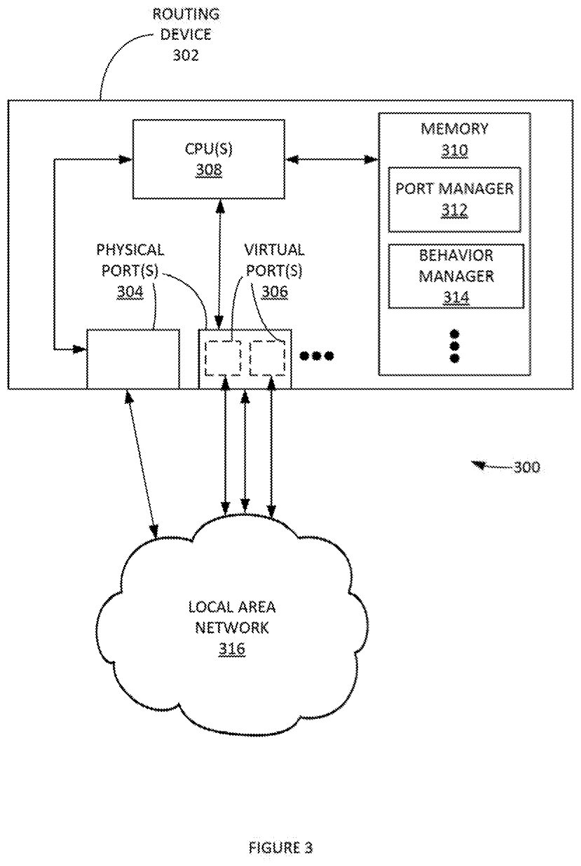

The captive-portal system provided herein can integrate the managing of a WIFI network and providing feedback forms/system. The captive-portal system can integrate these two systems together in a way that's natural and intuitive without taking explicit approaches such as making the end user install an app or visit a third party hosted feedback form via an email link. It is noted that, since the end user is connected to the local WIFI network, the captive-portal system implicitly knows that the user is present on site and so the venue stakeholders can still take corrective measures for recovery as the system sends out alerts (e.g. via email, slack, text message, etc.) in real time (e.g. assuming networking and/or processing latencies) to all registered stakeholders. In this way, user(s) can respond and provide feedback in substantially real time. The captive-portal system has a lower barrier to usage (which is that the end user needs to connect to the WIFI network and use it) than other feedback systems as once connected, upon every visit, the user's computing device would automatically reconnect! The systems of FIGS. 3-6 can be used to implement an example captive-portal system.

FIG. 3 is a block diagram illustrating selected elements of a physical routing device 302, according to some embodiments. Generally, routing device 302 can be used to forward data (traffic) to its proper destination (e.g., an end node, another router, etc.). More specifically, routing device 302 can be a port-based multitenancy router. Routing device 302 can manage/control a captive portal. Routing device 302 can control access to LAN 316 (e.g. Wi-Fi hotspot). In the example of FIG. 3, the routing device 302 can include, inter alia, a central processing unit(s) (CPUs) 308, a memory 310 and a number of ports including 304 and 306. CPUs 308, among its functions, can provide hardware management functions, run network control protocols, and execute the routing device's operating system. Memory 310, among its functions, stores instructions that can be executed by the CPU 308. Ports including 304 and 306 can provide a physical interface between routing device 302 and other electronic devices.

Memory 310 can further include a port manager 312 and a behavior manager 314. Port manager 312 can manage the behavior of ports 304 and 306. Port manager 312 can manage/control virtual ports within a physical port. Behavior manager 314 can include instruction for determining a status of a connected host device. Behavior manager 314 can assign host device to particular ports based on the host's status and the associated port's behavior. A host device can connect to routing device 302 via LAN 316. LAN 316 can be a wireless network.

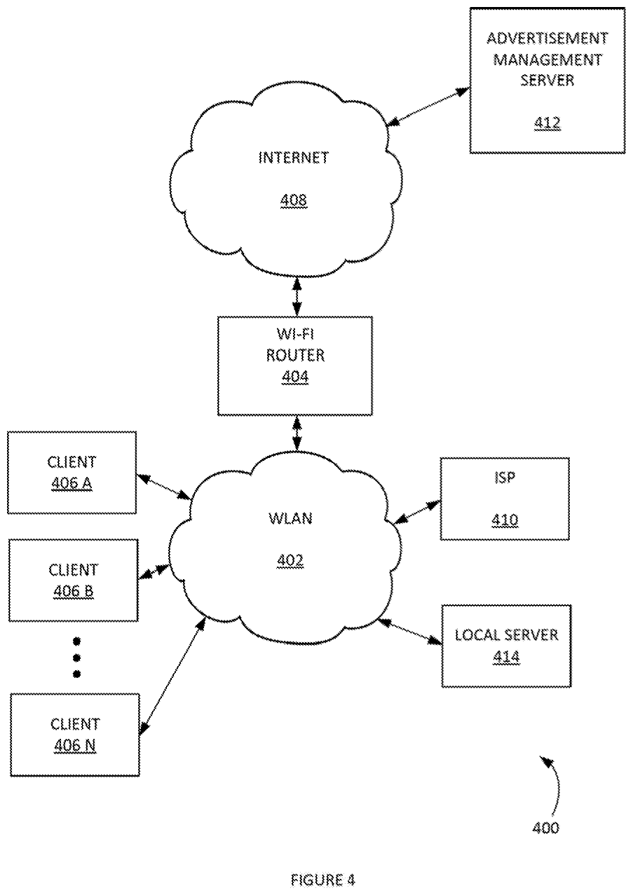

FIG. 4 depicts an architecture block diagram of an example captive-portal system 400, according to some embodiments. System 400 can include WLAN 402. WLAN 402 can be a hotspot (e.g. a Wi-Fi access point or area for connecting to the Internet 408) provided and managed by Internet service provider (ISP) 410. Clients 406 A-N can typically be web browsers that access Internet 408 via WLAN 402 and ISP 410. Clients 406 A-N can connect as host devices to WLAN 402. Clients 406 A-N can be assigned a status based on various factors (e.g. location, etc.). Clients 406 A-N can include web browsers. ISP 410 can manage/control a captive portal in WLAN 402 to ensure authentication of users of clients 406 A-N. Various techniques can be utilized by ISP 410 to redirect clients 406 A-N from the captive portal's authentication web page to advertisements such as client-side redirection, whitelisting of advertiser web pages at the WLAN's router level, caching of advertisement media content from within the WLAN, and the like. It is noted that the captive portal technique can be managed/controlled at the router level of the WLAN as well. Router level operations can be performed by Wi-Fi router 404. Wi-Fi router 404 can maintain an authenticated list of previously authenticated MAC addresses. Wi-Fi router 404 can be a port-based multitenancy router such as routing device 302 of FIG. 3.

Local server 414 can implement caching of advertisement media content from within the WLAN. For example, local server 414 can serve video advertisements via HTTP and/or RTSP locally from within the WLAN. Local server 414 can synchronize and download its media content from advertisement management server 412. This process can occur during periods when the WLAN's user traffic is ascertained to be low. The media content can be determined by the categorization of the WLAN and categorization of the campaigns (e.g. by location and/or local business entities who provide advertisements). For example, certain advertisements can be associated with certain IP addresses. Advertisement management server 412 can match the incoming WLAN IP address with an advertisement associated with it. Advertisement management server 412 can then replace the URL of the interstitial advertisement with the IP address of local server 414 so that the video can be served locally.

In one example, local server 414 can be a local caching device that can have a small form factor computer (e.g. ITX such as Mini-ITX, Nano-ITX, Pico-ITX, Mobile-ITX) with an x86 based microprocessor 32 or 64 bit, at least about 2 GB of RAM and a solid-state drive of at least 60 GB or greater. The local caching device can also include at least one Ethernet port through which it can connect to the Wi-Fi router directly and/or to a computer network to which the Wi-Fi router is connected. The local caching device can cache multimedia objects (such as video, audio, flash files and the like) locally. To achieve this, the local caching device can be on the same subnet as the WLAN network. In one example, advertisement management server 412 can include information about which hotspots have such a local caching device deployed locally (e.g. by IP address). As soon as an advertisement management server 412 receives a request for an advertisement from such a hotspot, it can serve the relevant page with the URL of such files set to the local NAT IP address of this device. For example, if a hotspot's IP address is 118.75.200.118 as known to an advertisement management server 412 and the internal network address translation (NAT) IP address of the local caching device is 192.168.1.254; then, instead of serving the advertisement page with the resource's URL as <video src=“/some/path/to/resource.mp4”>advertisement management server 412 can serve the URL as <video src=“http://192.168.1.254/path/to/resource.mp4”>.

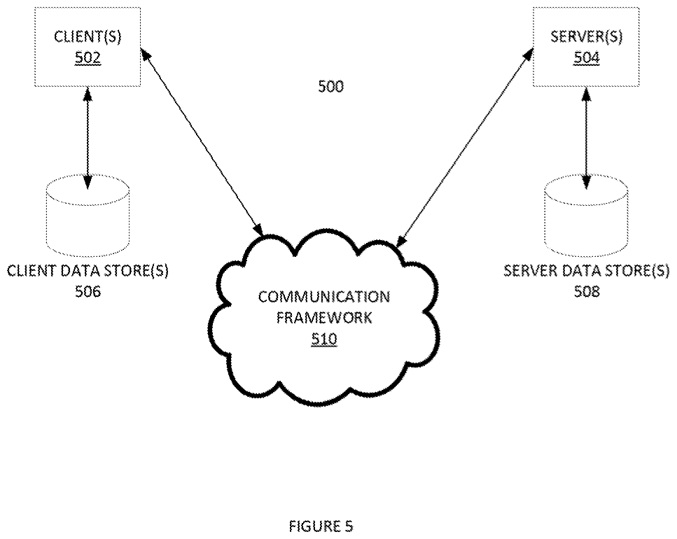

FIG. 5 is a block diagram of a sample-computing environment 500 that can be utilized to implement some embodiments. The system 500 further illustrates a system that includes one or more client(s) 502. The client(s) 502 can be hardware and/or software (e.g., threads, processes, computing devices). The system 500 also includes one or more server(s) 504. The server(s) 504 can also be hardware and/or software (e.g., threads, processes, computing devices). One possible communication between a client 502 and a server 504 may be in the form of a data packet adapted to be transmitted between two or more computer processes. The system 500 includes a communication framework 510 that can be employed to facilitate communications between the client(s) 502 and the server(s) 504. The client(s) 502 are connected to one or more client data store(s) 506 that can be employed to store information local to the client(s) 502. Similarly, the server(s) 504 are connected to one or more server data store(s) 508 that can be employed to store information accessible by the server(s) 504.

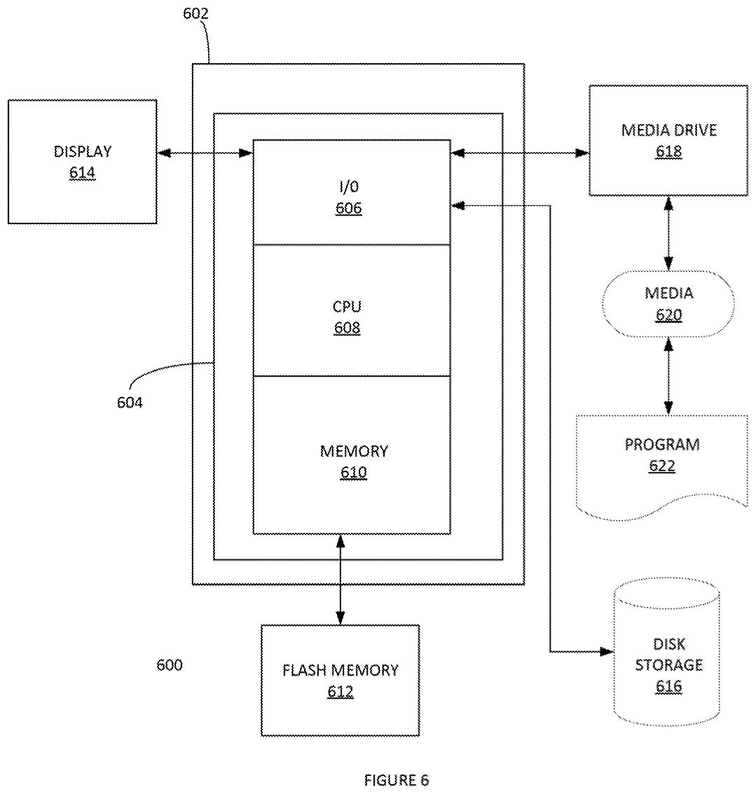

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities.

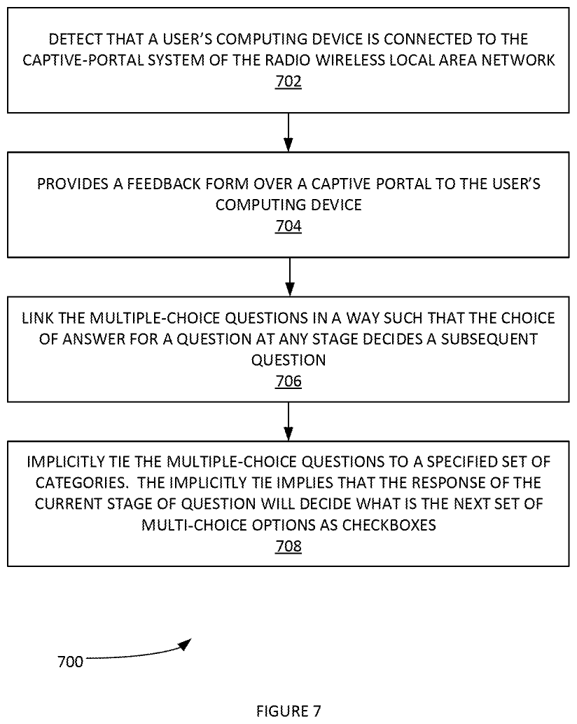

FIG. 7 illustrates an example process 700 useful for integrating a feedback gathering mechanism into a captive-portal system provided over a radio wireless local area network, according to some embodiments. In step 702, process 700 detects that a user's computing device is connected to the captive-portal system of the radio wireless local area network. The step 704, process 700 provides a feedback form over a captive portal to the user's computing device. The feedback form comprises a set of multiple-choice questions answerable by a user. In step 706, process 700 links the multiple-choice questions in a way such that the choice of answer for a question at any stage decides a subsequent question. In step 708, process 700 implicitly ties the multiple-choice questions to a specified set of categories such as housekeeping, internet, breakfast bar etc. The implicit-link implies that the response of the current stage of question will decide what is the next set of multi-choice options to be shown as checkboxes. For example, clicking smiley may show options related to what the user liked most vs clicking frowny may show a free text input box to describe what the user dislikes etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is:

1. A computerized process useful for integrating a feedback gathering mechanism into a captive-portal system provided over a radio wireless local area network, comprising:
detecting a user's computing device is connected to the captive-portal system of the radio wireless local area network;
providing a feedback form over a captive portal to the user's computing device, wherein the feedback form comprises a set of multiple-choice questions answerable by a user;
linking the multiple-choice questions in a way such that the choice of answer for a question at any stage decides a subsequent question; and
implicitly tie the multiple-choice questions to a specified set of categories.

2. The computerized method of claim 1, wherein the radio wireless local area network comprises a WIFI network.

3. The computerized method of claim 1, wherein the user's computing device comprises a smart phone, a tablet computer, or a laptop computer.

4. The computerized method of claim 1, wherein the specified set of categories are for a set of severity ranges.

5. The computerized method of claim 4, wherein the set of severity ranges is grouped into a good-feedback category, a neutral-feedback category and bad-feedback category.

6. The computerized method of claim 4, wherein the set of severity categories are customizable by an administrator of the captive portal.

7. The computerized method of claim 6, wherein the wherein the set of severity categories comprises a specified set of keywords and tags.

8. The computerized method of claim 7, wherein the specified set of keywords and tags are stored and available for search and specified grouping operations.

9. The computerized method of claim 8, wherein the feedback form comprises an independent mechanism that is served and displayed on the user's computing device when an Internet access via the WIFI network of the user's computing device is momentarily paused.

10. A computerized system useful for integrating a feedback gathering mechanism into a captive-portal system provided over a radio wireless local area network, comprising:
at least one processor configured to execute instructions;
a memory containing instructions when executed on the processor, causes the at least one processor to perform operations that:
detect a user's computing device is connected to the captive-portal system of the radio wireless local area network;
provide a feedback form as a captive portal to the user's computing device, wherein the feedback form comprises a set of multiple-choice questions answerable by a user;
link the multiple-choice questions in a way such that the choice of answer for a question at any stage decides a subsequent question; and
implicitly tying the multiple-choice questions to a specified set of categories.

11. The computerized system of claim 10, wherein the radio wireless local area network comprises a WIFI network.

12. The computerized system of claim 10, wherein the user's computing device comprises a smart phone, a tablet computer, or a laptop computer.

13. The computerized system of claim 10, wherein the specified set of categories are for a set of severity ranges.

14. The computerized system of claim 13, wherein the set of severity ranges is grouped into a good-feedback category, a neutral-feedback category and bad-feedback category.

15. The computerized system of claim 14, wherein the set of severity categories are customizable by an administrator of the captive portal.

16. The computerized system of claim 15, wherein the wherein the set of severity categories comprises a specified set of keywords and tags.

17. The computerized system of claim 16, wherein the specified set of keywords and tags are stored and available for search and specified grouping operations.

18. The computerized system of claim 17, wherein the feedback form comprises an independent mechanism that is served and displayed on the user's computing device when an Internet access via the WIFI network of the user's computing device is momentarily paused.

19. A computerized method useful for managing a captive portal of a radio wireless local area network comprising:
detecting that a user's computing device access to an Internet via a radio wireless local area network comprising a captive portal is paused;
determining a cause of the pause of the user's computing device access;
providing for a feedback form with a captive portal, wherein a user response to the feedback form functions as a constructive login to the radio wireless local area network via the captive portal;
detecting the user response to the feedback form; and
unpausing the access of the user's computing device access to the Internet.
